(19) United States
(12) Patent Application Publication
(10) Pub. No.: US 2019/0264764 A1
(43) Pub. Date: Aug. 29, 2019

(54) BRAKE PAD WEAR SENSOR

(71) Applicant: TRW AUTOMOTIVE U.S. LLC, Livonia, MI (US)

(72) Inventor: XING PING LIN, West Bloomfield, MI (US)

(21) Appl. No.: 16/319,888

(22) PCT Filed: Aug. 1, 2017
(86) PCT No.: PCT/US17/44779

§ 371 Date: Jan. 23, 2019

Related U.S. Application Data
(60) Provisional application No. 62/369,803, filed on Aug. 2, 2016.
(60) Provisional application No. 62/369,810, filed on Aug. 2, 2016.

(51) Int. Cl. F16D 66/02; G01B 7/06

(52) U.S. Cl. CPC F16D 66/023; G01B 5/0028; G01B 7/107

(57) ABSTRACT

A brake pad wear measuring system for measuring brake pad wear for a vehicle disc brake system includes an inductive sensor operable to create a magnetic field and a target. At least one of the sensor and the target are mounted for movement along a braking axis with a component of the disc brake system. The positions of the sensor and target relative to each other changes in response to application of the disc brake system. The distance that the sensor and target move relative to each other in response to application of the disc brake system increases an amount that is equal to the total wear of the inner and outer brake pads. The sensor is responsive to the change in inductance caused by movement of the target in the magnetic field to provide a signal indicative of brake pad wear.

### RELATED APPLICATION

This application claims the benefit of U.S. Provisional Application Ser. No. 62/369,803, filed on Aug. 2, 2016, and U.S. Provisional Application Ser. No. 62/369,810, filed on Aug. 2, 2016. The disclosures in these applications is hereby incorporated herein by reference in their entireties.

### TECHNICAL FIELD

The invention relates generally to brake pad wear sensing systems and devices. More particularly, the invention relates to a brake pad wear sensor that measures wear in both inner and outer brake pads of a disc braking system.

### BACKGROUND

It is desirable to sense and inform the driver when automotive brake pads need to be replaced. Known electronic brake wear sensors have a resistor circuit sensor that is cupped to the inner brake pad. As the pad is abraded away by the rotor, the sensor is also abraded away; changing its resistance. A pigtail harness is connected to the sensor which is wired to a sensing module in the vehicle.

There are several problems with the known approach. The multiple wire harnesses required and the additional sensing module makes this an expensive solution. Routing of the harnesses through the vehicle suspension and the wheel/steering knuckle area is very challenging and prone to road debris abuse. Additionally, the wear sensor has to be replaced each time the pads are replaced, which can be expensive.

While employing electronic sensors to detect brake pad wear, it is important to consider that the brake pad and brake caliper area can reach temperatures in excess of 300 degrees C., which many electronic sensors cannot withstand.

From a cost and implementation standpoint, it is desirable to not use any wire harness and to try to utilize existing product already on the vehicle to reduce the cost of transporting the pad wear information to the driver display. It is also desirable that it not be necessary to replace the brake pad wear sensor with the brake pads when they are replaced. It is also desirable that the brake pad wear sensor provides diagnostic (e.g., heartbeat) capabilities, and the sensor must be capable of withstanding the extreme temperatures seen during braking.

### SUMMARY

A re-usable inductive brake pad wear sensor is adapted for the brake pad environment, which is harsh in temperature and cleanness (e.g., dirt, mud, rain, road salt, etc.). Certain electronic sensing methodologies, such as infrared (IR) sensing, ultrasonic sensing, and capacitive sensing can be negatively affected by these harsh environmental conditions. Advantageously, inductive sensing is affected to a much lesser extent by these conditions. Inductance is affected by the metal structure in the environment in which it is implemented but, as long as that structure remains constant or substantially constant, the effects of the metal structure can be taken into consideration and dealt with accordingly.

According to one aspect, a system and method measures the brake pad thickness directly via an inductive axial distance sensor. According to another aspect, a system and method measures the brake pad thickness locally via an inductive axial distance sensor. According to another aspect, a system and method indirectly measures the brake pad thickness by measuring, via an inductive distance sensor, the axial distance between a fixed reference point to a target object attached directly or indirectly to the brake pad. According to further aspect, a system and method indirectly measures the brake pad thickness by measuring, via an inductive distance sensor, the lateral distance between a fixed reference point to a target object attached directly or indirectly to the brake pad.

Advantageously, measuring the distance from a location remote from a target attached directly or indirectly to the brake pad makes it possible to place the remote component out of the high-temperature environment of the brakes. Since the target can be nothing more than a simple metal plate, its position in or near the high-temperature environment of the brakes is of no consequence. Thus, the inductive brake pad wear sensing device can withstand the harsh conditions, i.e., high temperature, dirt, mud, water, etc., of the brake pad environment.

The inductive brake pad wear sensor includes a base that is mounted at a fixed position relative to the brake pad for which thickness is being measured. A target, such as a metal plate, is mounted directly or indirectly to the brake pad so as to travel with the brake pad. The base includes an inductance measuring circuit and it is through this circuit that the distance from the base to the target is measured. As the brake pad wears, it must travel farther when the vehicle brakes are applied. Therefore, when the inductive sensor measures an increase in the distance that the brake pad moves, it can be correlated to wear in the pad. The brake pad thickness change thus translates to the movement detected with inductive sensor.

While temperature can affect measurement results, the system can compensate for these effects by measuring the temperature and applying a known compensation techniques. The system can also implement some unique implementation techniques, such as configuring the sensor to include an uneven target metal plate against uneven coil to accelerate the field change rate. The system can also implement a 3D target plate to enhance lateral sensing.

According to one aspect, a brake pad wear measuring system for measuring brake pad wear for a vehicle disc brake system includes an inductive sensor operable to create a magnetic field and a target. At least one of the sensor and the target are mounted for movement along a braking axis with a component of the disc brake system. The positions of the sensor and target relative to each other changes in response to application of the disc brake system. The distance that the sensor and target move relative to each other in response to application of the disc brake system increases an amount that is equal to the total wear of the inner and outer brake pads. The sensor is responsive to the change in inductance caused by movement of the target in the magnetic field to provide a signal indicative of brake pad wear.

According to another aspect, alone or in combination with any other aspect, the target can have a face that extends along a target plane and is oriented parallel with a coil winding plane of the sensor. The movement of the target relative to the sensor can be along an axis that extends perpendicular to both the target plane and the coil winding plane.

According to another aspect, alone or in combination with any other aspect, the target can have a face that extends along a target plane and is oriented parallel with a coil winding plane of the sensor. The movement of the target relative to the sensor can be along an axis that extends parallel to both the target plane and the coil winding plane.

According to another aspect, alone or in combination with any other aspect, the system can be configured so that the target is offset from the coil prior to brake application and moves over the coil in response to brake application.

According to another aspect, alone or in combination with any other aspect, the axial spacing of the target and the sensor as measured parallel to the braking axis can remain constant throughout brake application.

According to another aspect, alone or in combination with any other aspect, the target can be tapered as viewed perpendicular to the target plane.

According to another aspect, alone or in combination with any other aspect, the target can have a stepped configuration as viewed parallel to the target plane.

According to another aspect, alone or in combination with any other aspect, the target can have a face that extends along a target plane and is oriented at an angle with respect to a coil winding plane of the sensor. The movement of the target relative to the sensor can be along an axis that extends parallel to both the target plane and the coil winding plane. The target can be tapered as viewed perpendicular to the target plane.

According to another aspect, alone or in combination with any other aspect, the target can have a face that is curved and extends along curved path such that a leading edge of the target is positioned farthest from the sensor coil.

According to another aspect, alone or in combination with any other aspect, the sensor can include an RFID initiator device and the target can include an RFID tag device.

According to another aspect, alone or in combination with any other aspect, the RFID initiator device can include an initiator coil, an amplifier for delivering power for exciting the initiator coil, and a controller for controlling the operation of the amplifier. The RFID initiator device can determine the wear on the brake pads in response to the power required from the amplifier to elicit a response from the RFID target device.

According to another aspect, alone or in combination with any other aspect, the target can be mounted for movement with a floating caliper or a piston of a floating caliper disc brake system wherein the piston supports an inner brake pad and the floating caliper supports an outer brake pad, and wherein the piston and floating caliper move toward each other along the braking axis in response to application of the brake system so that the brake pads engage and apply a braking force to a brake rotor.

### BRIEF DESCRIPTION OF THE DRAWINGS

The foregoing and other features and advantages of the present invention will become apparent to those skilled in the art to which the present invention relates upon reading the following description with reference to the accompanying drawing, in which:

FIG. 1 is a schematic illustration of an example vehicle configuration showing disc brake components mounted on vehicle suspension components.

FIG. 2 is a schematic illustration depicting a brake wear sensor system implemented on an example disc brake configuration, wherein the disc brake is shown in a non-braking condition.

FIG. 3 is a schematic illustration depicting the brake wear sensor system of FIG. 2, wherein the disc brake is shown in a first braking condition with brake pads at a first level of wear.

FIG. 4 is a schematic illustration depicting the brake wear sensor system of FIG. 2, wherein the disc brake is shown in a second braking condition with brake pads at a second level of wear.

FIGS. 5A and 5B are schematic illustrations depicting one configuration of the brake wear sensor system.

FIGS. 6A and 6B are schematic illustrations depicting another configuration of the brake wear sensor system.

FIGS. 7A and 7B are schematic illustrations depicting another configuration of the brake wear sensor system.

FIGS. 8A and 8B are schematic illustrations depicting another configuration of the brake wear sensor system.

FIGS. 9 and 10 are schematic illustrations depicting another configuration of the brake wear sensor system.

FIG. 11 is a schematic block diagram depicting an example configuration of certain elements of the brake wear sensor system.

FIG. 12 is a flow diagram illustrating by way of example a manner in which the brake wear system of FIG. 11 can operate.

FIGS. 13A and 13B are schematic illustrations depicting another configuration of the brake wear sensor system.

FIG. 14 is a flow diagram illustrating by way of example a manner in which the brake wear system of FIGS. 13A and 13B can operate.

### DETAILED DESCRIPTION

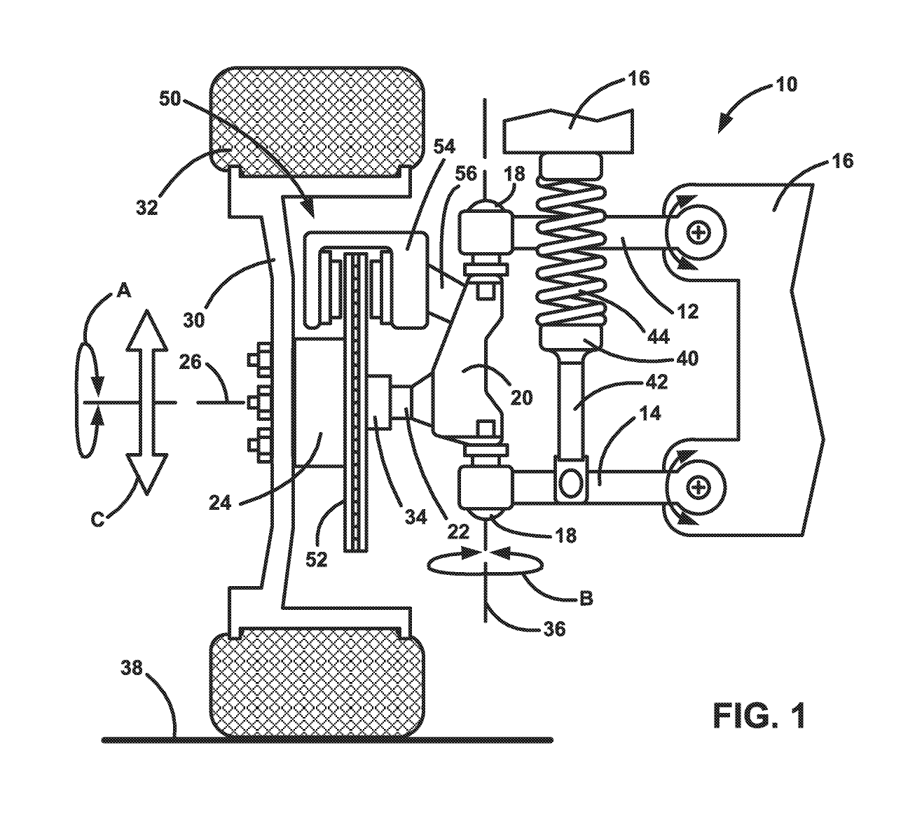

Referring to FIG. 1, an example vehicle suspension system 10 includes an upper control arm 12 and a lower control arm 14 that are connected to the vehicle 16 for pivoting movement. A steering knuckle 20 is connected to free ends of the control arms 12, 14 by ball joints or the like that permit relative movement between the knuckle and control arms. The steering knuckle 20 includes a spindle 22 that supports a wheel hub 24 for rotation (see arrow A) about a wheel axis 26. A wheel or rim 30 and tire 32 can be mounted on the wheel hub 24 by known means, such as lugs and lug nuts. The wheel hub 24 includes bearings 34 that facilitate rotation of the hub, rim 30, and tire 32 about the axis 26. The steering knuckle 20 is itself rotatable about a steering axis 36 (see arrow B) to steer the vehicle 16 in a known manner.

A damper 40, such as a shock absorber or strut, has a piston rod 42 connected to the lower control arm 14 and a cylinder 44 that is supported by structure of the vehicle 16, such as a vehicle frame-mounted bracket. The damper 40 dampens relative movement of the control arms 14, 16, and the steering knuckle 20 relative to the vehicle 16. The damper 40 can thus help dampen and absorb impacts between the road 38 and the tire 32, such as impacts with bumps, potholes, or road debris, that produce up and down movement (see arrow C) of the suspension system 10, the wheel 30, and the tire 32.

The vehicle 16 includes a disc braking system 50 that includes a brake disc 52 secured to the hub 24 for rotation with the hub, wheel 30, and tire 32. The disc braking system 50 also includes a brake caliper 54 that is secured to the steering knuckle 20 by a bracket 56. The disc 52 and the caliper 54 thus move in unison with the steering knuckle 20 through steering movements (arrow B) and suspension movements (arrow C). The disc 52 rotates (arrow A) relative to the caliper 54 and has an outer radial portion that passes through the caliper.

The configuration of the suspension system 10 shown in FIG. 1 is by way of example only and is not meant to limit the scope of the invention. The brake pad wear sensor system disclosed herein can be configured for utilization with any vehicle suspension configuration that implements disc brakes. For example, while the illustrated suspension system 10 is an independent front suspension, specifically an upper and lower control arm/A-arm (sometimes referred to as a double wishbone) suspension, other independent suspensions can be used. Examples of independent suspensions with which the brake pad wear sensing system can be implemented include, but are not limited to, swing axle suspensions, sliding pillar suspensions, MacPherson strut suspensions, Chapman strut suspensions, multi-link suspensions, semi-trailing arm suspensions, swinging arm suspensions, and leaf spring suspensions. Additionally, the brake pad wear sensing system can be implemented with dependent suspension systems including, but not limited to, Satchell link suspensions, Panhard rod suspensions, Watt's linkage suspensions, WOB link suspensions, Mumford linkage suspensions, and leaf spring suspensions. Furthermore, the brake pad wear sensing system can be implemented on front wheel disc brakes or rear wheel disc brakes.

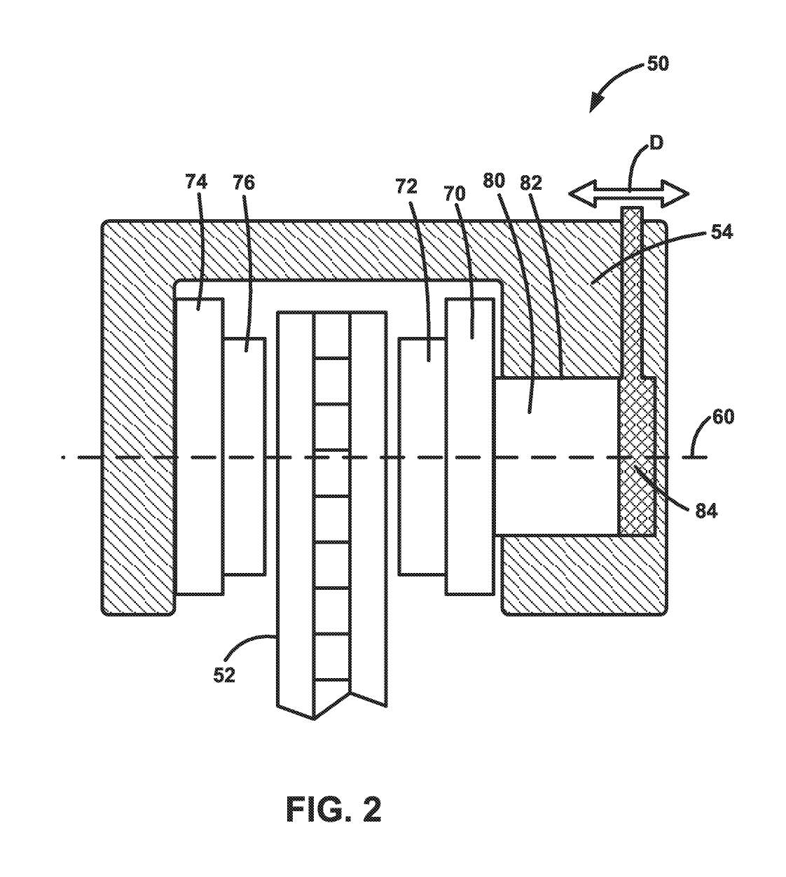

Referring to FIGS. 2-4, the disc braking system 50 is illustrated schematically and in greater detail. The brake system 50 is a single piston floating caliper system in which the connection of the caliper 54 to the vehicle 16 allows for axial movement of the caliper (“float”) relative to the brake disc 52. In this floating caliper configuration, the caliper 54 is permitted to move axially toward and away from the disc 52 (see arrow D) parallel to a braking axis 60.

The brake system 50 includes an inner brake pad holder 70 that supports an inner brake pad 72, and an outer brake pad holder 74 that supports an outer brake pad 76. The inner brake pad holder 70 is supported on a piston 80. The outer brake pad holder 74 is supported on the floating caliper 54. The piston 80 is disposed in a cylinder 82 that is supported on or formed in the floating caliper 54. Brake fluid 84 is pumped into the cylinder 82 in response to driver application of a brake pedal (not shown) in order to actuate the braking system 50.

The brake system 50 is maintained in the unactuated condition of FIG. 2 via bias applied by a biasing member (not shown), such as a spring. When the brake pedal is applied, the brake fluid 84 fills the cylinder 82 and applies fluid pressure to the piston 80, urging it to move to the left, as viewed in FIGS. 2-4. This causes the inner brake pad holder 70 and pad 72 to move along the braking axis 60 toward and the brake disc 52. The inner brake pad 72 engaging the disc 52 creates a reaction force that acts on the floating caliper 54, due to its supporting of the piston 80 and cylinder 82. Since the piston 80 is blocked against movement toward the disc 52 due to the engagement of the inner brake pad 72 with the disc, the brake fluid pressure in the cylinder 82 urges the floating caliper 54 to move to the right, as viewed in FIGS. 2-4, The floating caliper 54, moving to the right, causes the outer brake pad holder 74 and pad 76 to move along the braking axis 60 toward the brake disc 52. The inner pad 76 eventually engages the disc 52, which is now clamped between the inner and outer brake pads.

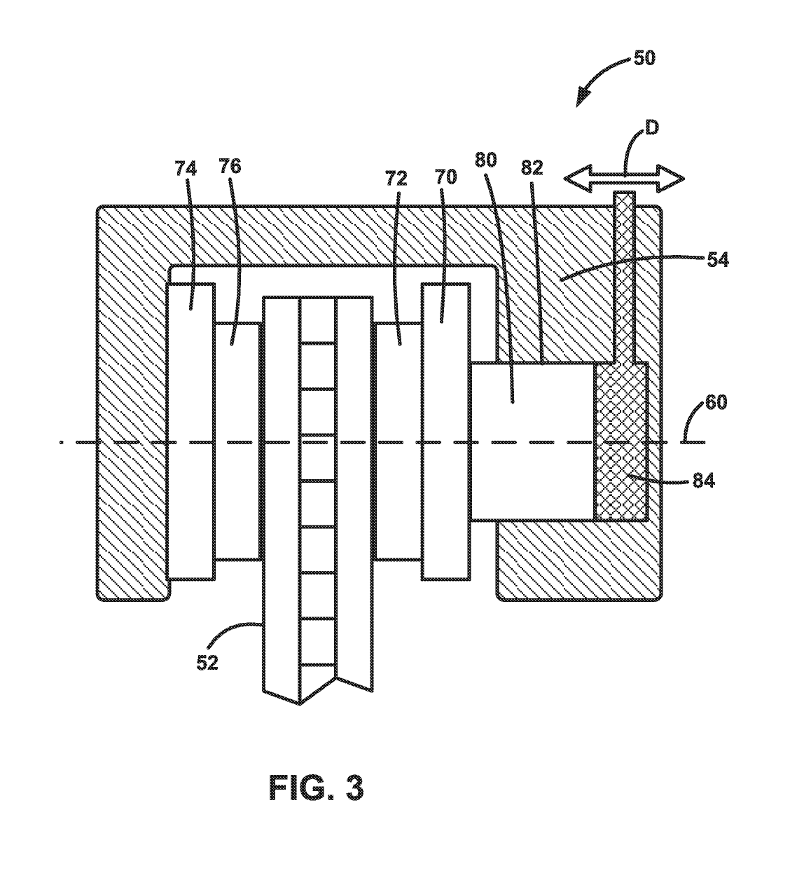

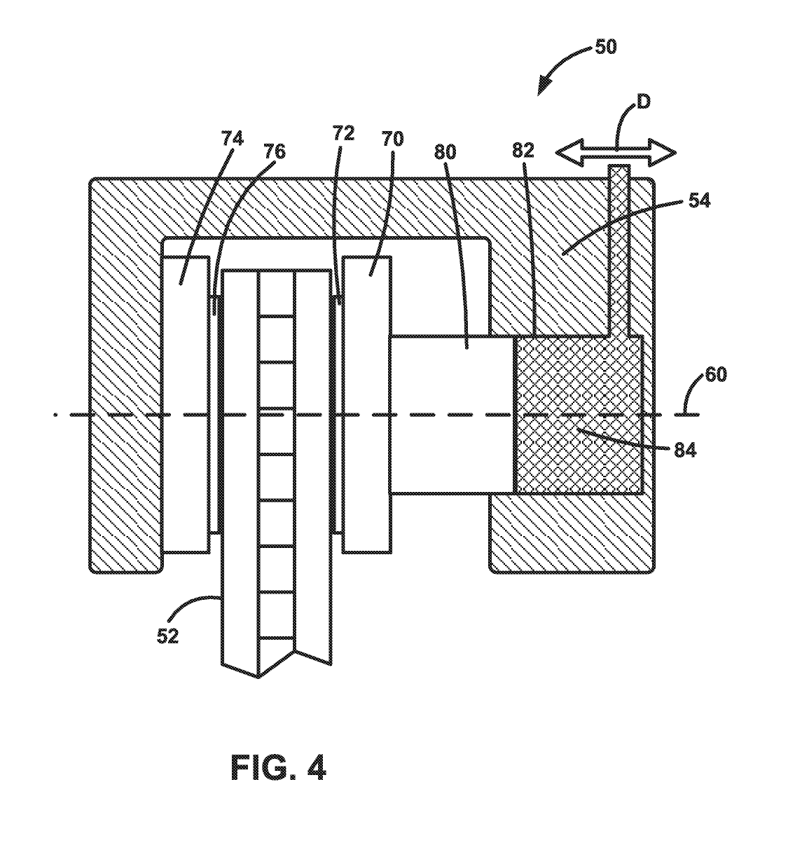

As the brake pads 72, 76 wear down, they become thinner. This is illustrated by comparing the brake pads 72, 76 of FIG. 3, which are fresh, thick, and unworn, to the brake pads of FIG. 4, which are old, thin, and worn-out. As seen in the comparison of FIGS. 3 and 4, owing to the floating caliper configuration of the brake system 50, both the piston 80 and the caliper 54 travel a greater distance when applying the worn pads of FIG. 4 than they do when applying the unworn pads.

A brake pad wear sensing system 100 measures the amount of wear in the brake pads 72, 76 without destroying any portion of the system. In this manner, there are no portions of the wear sensing system 100 that require replacement during routine maintenance and brake pad replacement. The wear sensing system 100 achieves this by measuring directly the distance that braking components travel during brake application. When the brake pads are new, the travel distance is short. As the pads wear, the travel distance increases. By measuring and monitoring this travel distance, the wear sensing system 100 can determine both the degree of brake pad wear and the point at which the pads are considered to be worn out.

The travel distance can be measured via a variety of the brake system 50 components. For example, the travel distance can be measured via the pads 72, 76 themselves, the pad holders 70, 74, the floating caliper 54, or the piston 80. The travel distance can be measured between the moving components themselves, or between a moving component and a stationary component. The stationary component can be a component of the brake system 50, or a component of the vehicle 16, such as the suspension system 10. When the brake pads 72, 76 are new or unworn, the travel distances are comparatively small. As the brake pads 72, 76 wear, the travel distances increase. An increase in the travel distance is indicative of the wear on the brake pads.

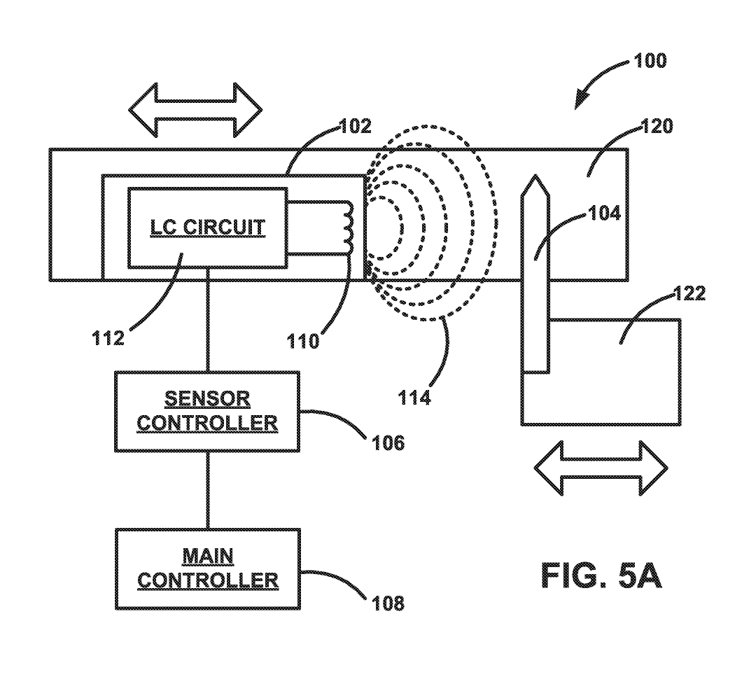

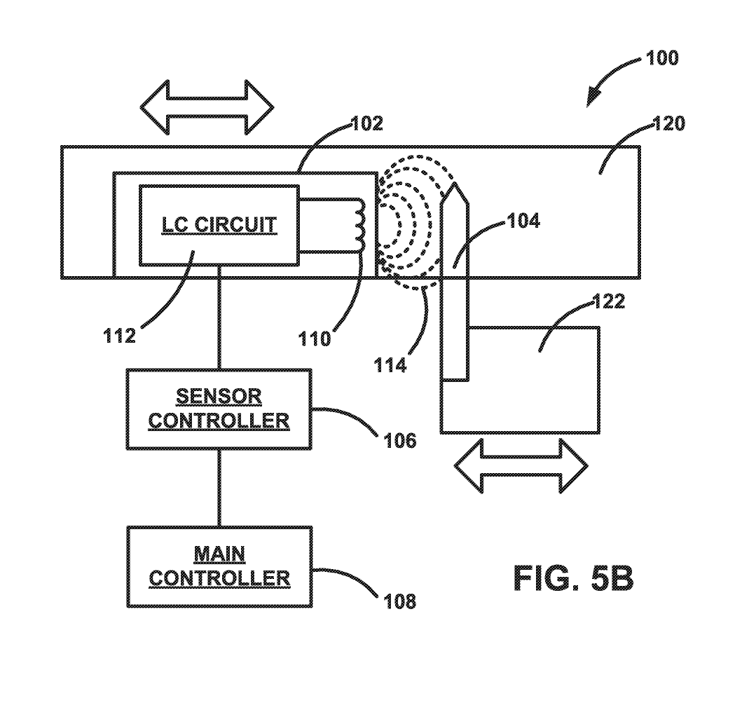

Referring to FIGS. 5A-B, the brake pad wear sensor system 100 includes an inductive sensor 102 and a target 104. The sensor 102 is mounted on a first component 120. The target 104 is mounted on a second component 122. As described in the previous paragraph, the first and second components 120, 122 can have various identities, such as a brake system 50 component, a vehicle 16 component, and a suspension system 10 component. The sensor 102 and target 104 can be mounted for movement in response to brake application (see the arrows in FIGS. 5A-B) or to remain stationary during brake application, as long as at least one component, the sensor 102 and/or the target 104, moves in response to brake application.

### The Inductive Sensor

Due to its not being influenced by dirt and corrosion and not requiring physical contact, the inductive sensor 102 is ideal for implementation in the brake pad wear sensing system 100. Inductive proximity sensing can be implemented as a binary indication, i.e., in an “yes/no” configuration, that provides a “time to replace” indication for the brake pads 72, 76. Inductive proximity sensing can also be implemented as a wear indicator, i.e., with a variable output configuration that can provide, for example, a “percent worn” indication, as well as a “time to replace” indication, for the brake pads 72, 76.

Referring to FIGS. 5A and 5B, the sensor 102 includes an inductive coil 110 and an LC circuit 112 for exciting the coil and for detecting the target 104. The LC circuit 112 includes an inductor-capacitor (LC) tank circuit and an oscillator for pumping the LC tank circuit. The inductor of the LC tank circuit is the coil 110, which produces a magnetic field 114 when the oscillator pumps the LC tank circuit. When the target 104 is distant from the sensor 102 (see FIG. 5A), the actuator has little or no affect on the field 114 produced by the sensor 102. As the target 104 is brought near the coil (see FIG. 5B), eddy currents form in the conductive metal of the actuator. The magnitude of the eddy currents varies as a function of the distance, the material, and the size of the target 104. The eddy currents form an opposing magnetic field that has the effect of reducing the oscillation amplitude in the LC tank circuit and reduce the effective inductance of the L inductor.

The L inductance value determine LC tank resonating frequency. So the sensor can be set up to measure either the oscillator amplitude change at LC tank circuit or LC tank resonating frequency change. t. The LC circuit 112 is configured to measure this change in order to detect the target 104. The manner in which the sensor 102 detects the target 104 depends on the configuration of the LC circuit 112. In one configuration, the LC circuit 112 can be configured to detect the presence of the actuator, i.e., a yes/no switch that is toggled when the target 104 reaches a certain predetermined position relative to the sensor. In another configuration, the LC circuit 112 can be configured to determine the actual distance to the target 104.

The brake pad wear sensor system 100 of the example configuration of FIGS. 5A and 5B can be configured as a worn pad detector (presence detector) or a pad wear detector (distance detector). In a worn pad detector configuration, the system 100 is configured to detect only when the brake pads have reached a predetermined amount of wear and to provide an indication that the pads are worn and require servicing. In a pad wear detector configuration, the system 100 is configured to detect the amount of the wear on the pads (e.g., % wear) and to provide an indication of that amount, such as the amount of wear on the pads or the useful life remaining in the pads. The system 100 can e configured to provide periodic warnings as the pads are worn, such as “50% remaining,” “25% remaining,” “10% remaining,” and “service required.”

In operation, when the position of the target 104 changes relative to the piston of the sensor 102, i.e., from the position illustrated in FIG. 5A to the position illustrated in FIG. 5B, this causes the magnetic field 114 to change and the LC circuit 112 to respond, with the sensor 102 providing an output to a sensor controller 106, which performs relevant calculations to determine brake pad wear and whether the brake pads require replacement. It should be noted that, depending on the placement of the sensor 102 and target 104, the wear sensing system 100 can be configured to detect increased wear as a function of increased distance between the sensor and the target, or to detect increased wear as a function of decreased distance between the sensor and the target. The sensor controller 106 can provide the results of these calculations to a main controller 108, such as a vehicle body control module (BCM), which can alert the vehicle operator when necessary.

In one particular configuration, the controller 106 can be implemented in or along with a vehicle anti-lock braking system (ABS) controller. This can be convenient because the ABS system, employing tire rotation sensors, already requires that cables/wiring be routed to the area, which the brake pad wear sensing system 100 can take advantage of. Implementing the controller 106 in/along with the ABS controller is also convenient since it communicates with a main controller 108. In this manner, the brake pad wear indications sensed by the system 100 can be transmitted to the main controller 108 via the sensor controller 106, which can provide the relevant alerts/indications to the vehicle operator, for example, via the instrument panel/gauge cluster.

In another configuration, the sensor 102 can transmit pad wear data wirelessly to the controller 106, which can then relay the data and/or calculations made using the data to the main controller 108. In this configuration, for example, the sensor controller 106 can be implemented in or along with a tire pressure monitoring system (TPMS) controller which is already outfitted to receive wireless signals from TPMS sensors and to communicate with the main controller 108.

In a further configuration, the sensor controller 106 can be integrated in the sensor 102 itself, and the sensor can transmit pad wear data and/or calculation results directly to the main vehicle controller 108, either wired or wirelessly.

### Direct Measurement at the Pad Implementation

According to one implementation of the sensor system 100, the inductive sensor 102 can be mounted on the pad holder for either the inner brake pad 72 or the outer brake pad 76. Since the relative positions of the brake rotor 52 and the brake pad holders 70, 74 are maintained close to each other, the rotor itself can act as the target 104. Thus, for this configuration, in FIGS. 5A-B, the component 120 is one of the pad holders 70, 74 and the component 122 is the brake rotor 52 (see FIGS. 2-4). The sensor 102, being mounted on the pad holder 70, 74 and being movable with the associated brake pad 72, 76, will get closer to the rotor 52 when the brakes are applied. Over time, as the pads 72, 76 wear, the sensor 102 will get progressively closer to the rotor 52, causing a change in the field generated by the inductive sensor, which can be detected and used to determine brake pad wear, as described.

In this implementation, the sensor system 100 can be configured to account for some potential drawbacks. First, since the amount of distance that can be measured is related to the diameter of inductive sensor coil 110, the geometry and spacing of the sensor 102 and target 104 can necessitate a large surface area for mounting the sensor, which may not be available. Accordingly, it may be desirable to implement a ferrite sensor coil, because these are known to exhibit increased field focus in the axial direction. Additionally, since the temperature on the back plate where the sensor is mounted on can be very hot, the sensor housing can require a special housing material. This heat may limit the components of the sensor 102 that can be positioned in this high temperature zone to the coil 110 and capacitors of the LC circuit 112. The remaining components of the sensor 102 can be included in a separate, remotely located unit connected, for example via wire.

Direct Measurement Remote from the Pad Implementation

According to another implementation of the sensor system 100, the inductive sensor 102 can be mounted remotely from the pad and pad holder. In this embodiment, due to the high temperatures and limited space in the area of the brake pad wear, the component 120 to which the brake pad wear sensor 102 is mounted can be remote from the high temperature area. Recalling that either or both of the first and second components 120, 122 can the move in response to brake application, the sensor 102 can measure this distance to determine brake pad wear in the manner described above. Positioning the sensor 102 in a remote location can, however, result in there being a lack of native structure to use as the target 104. In this instance, the target 104 can be configured to extend from the second component 122 so that it is positioned at a location where its effect on the field 114 in response to brake application can be measured. This is shown in FIGS. 5A-B. Advantageously, this allows the target 104 to have a specific configuration (e.g., size, area, thickness, material, etc.) that is tailored to optimize the sensing capabilities of the system 100 in terms of reliability, accuracy, and precision.

In this implementation, the first and second components 120, 122 can have a variety of identities. Referring to FIGS. 2-4, the first component 120 can be the floating caliper 54, which would allow the sensor 102 to move in response to application of the brakes. Alternatively, the first component 120 can be a stationary component, such as the mounting bracket 56 or a component of the suspension system 10. The second component 122 can be a moving brake system component, such as the caliper 54, the piston 80, one of the pad holders 70, 74, or one of the pads 72,76.

### Indirect Measurement Implementation

According to another implementation of the sensor system 100, the first and second components 120 and 122 to which the inductive sensor 102 and the target 104 are mounted can be any of the combinations set forth above. Because effective measurement of the target distance from the inductive sensing coil (D_{S}) is associated with the coil size/diameter, it follows that the larger the coil 110, the better the measurement. Due to the limited space in the area of the brake system 50, and owing to the fact that there are many metal components in that area, a large size/diameter coil may not be possible. Additionally, brake pad thickness can change relatively little (e.g., about 10-15 mm) over its lifetime. This limited space for the sensor 102 and relatively small distance D_{S}, in combination with some tolerance stack up related to surrounding structures, such as vehicle, brake, and suspension components, it can be challenging to sense a small change in axial distance between the sensor 102 and the target 104.

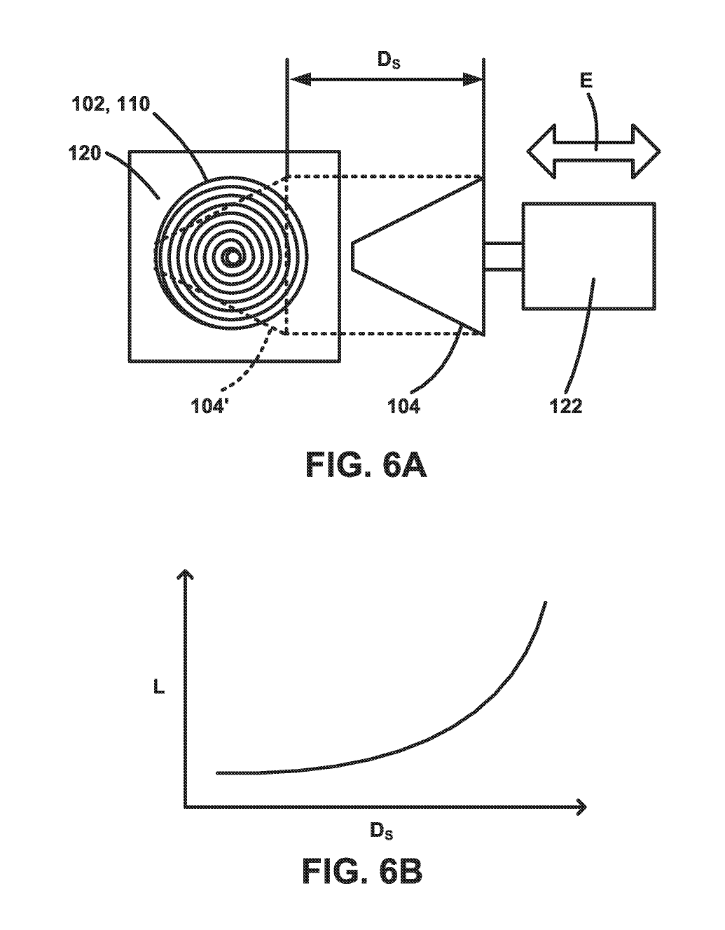

Therefore, according to this example configuration of the sensor system 100, the brake pad thickness can be translated into a lateral position of the target 104 relative to the sensor 102/coil 110. Instead of measuring the axial distance between the face of the coil 110 and the face of the target 104, the spacing between the coil and target faces is maintained constant, and the target is configured to move laterally over the coil. This is shown in FIGS. 6A-B. As shown FIG. 6A, the target 104 has an irregular, generally triangular shape and is configured to move laterally (as indicated by arrow E) over the coil 110 of sensor 102 in response to brake actuation.

The irregular shape of the target 104 and the fact that its spacing from the surface of the sensor coil 110 is maintained constant and small improves the response of the sensor 102 to the presence of the target. In this variable target configuration, As shown in FIG. 6A, the area of the triangular target that is exposed to the coil changes as it slides/moves over/along the coil. As the target moves relative to the coil, the surface area of the target changes. The effects that this movement has on the coil inductance L is change as shown in the graph of FIG. 6B. The reduction in coil inductance resulting from the movement of the target 104 over the coil 110 can be measured, for example as a resonating frequency increase in the parallel resistance of the LC circuit or reduced signal amplitude, and used to indicate the position of the target relative to the coil, which can be correlated to a change in thickness (and wear) of the associated brake pad.

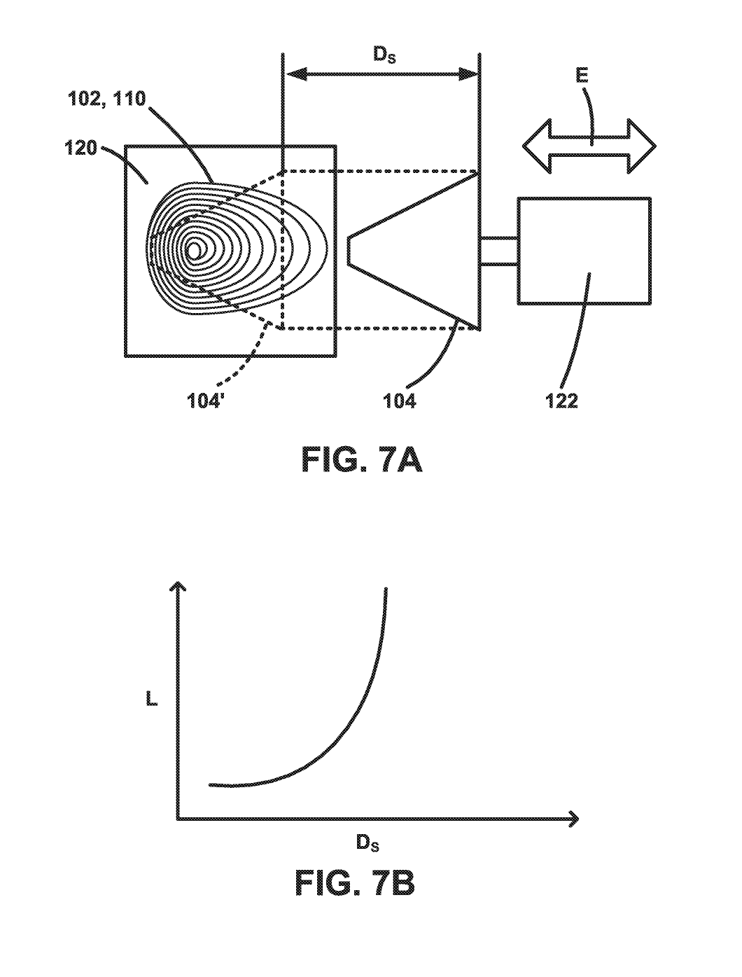

Following these same principles, it will be appreciated that certain modifications can be implemented to help improve the performance of the sensor system 100. For example, the target can be constructed in shapes other than triangular and can, for example, vary in both shape and thickness. Additionally, a multi-stage sensor (e.g., 25%, 50%, 75%, 90% worn) by correlating those wear positions with changes in target shape and/or thickness. Additionally or alternatively, the shape of the coil can also be configured so that the strength of the field it produces varies across its face varies so that the coil responds differently to incremental changes in target position. For example, in FIG. 7A, both the coil 110 and the target 104 are irregularly shaped so that the response to movement of the target (change in D_{S}) is increased, as shown in FIG. 7B.

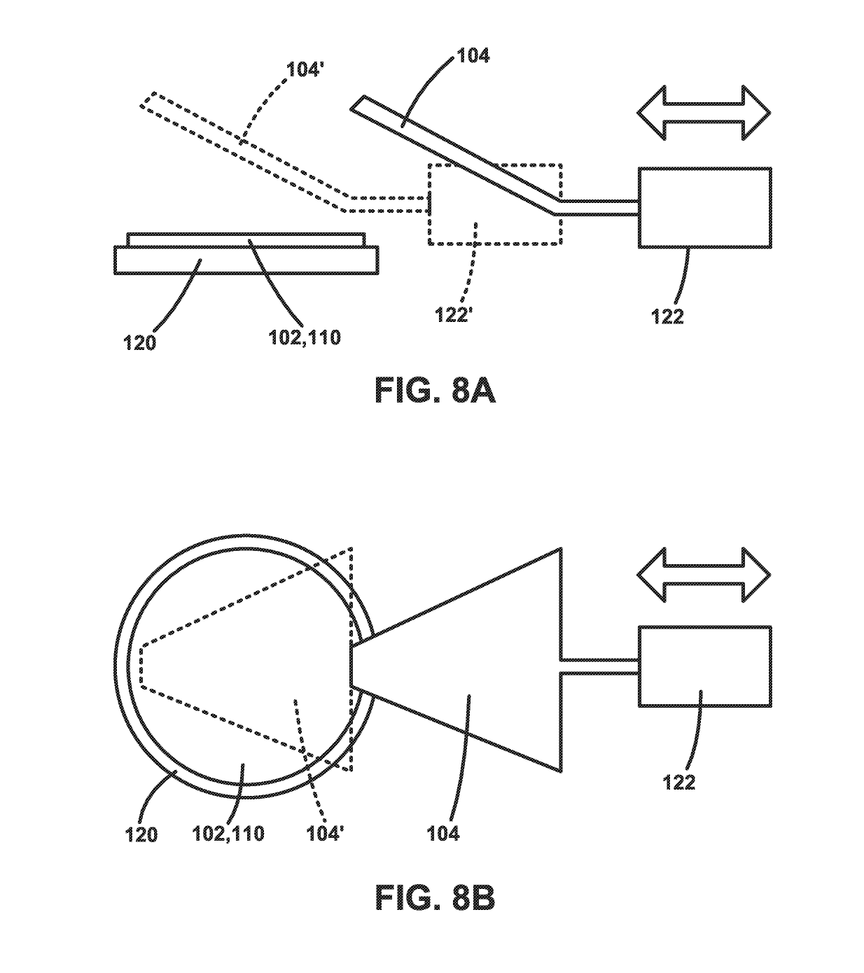

Referring to FIGS. 8A-B, the spacing between the target 104 and the sensor 102/coil 110 can be variable in order to improve the response of the sensor system 100. As shown in FIG. 8A, the target 104 is angled with respect to the direction of travel (see the arrow) of the target in response to brake application. As shown in FIG. 8B, the target 104 can also have a variable shape (e.g., triangular) in order to further improve the sensor response. As the first and second components 120, 122 move relative to each other in response to brake application, the sensor 102 can provide an output indicative of the brake pad wear.

This configuration gives the target 104 a three-dimensional structure, which further lends to its efficiency, performance, resolution, response, etc. In this configuration, the 3D target 104 has a surface area that changes due to its shape (see FIG. 8B) and also due to the axial positioning of different portions of the target due to the added 3D aspects of its configuration. Thus, as the lateral position of the target 104 and coil 110 change, the target plate surface area will change due to the triangular shape while, at the same time, the axial distance between the target and the coil also changes due to the 3D structure. Advantageously, this 3D target configuration can help accelerate the field change or inductance change of the coil (or loss change), and can also help improve the accuracy of the sensor.

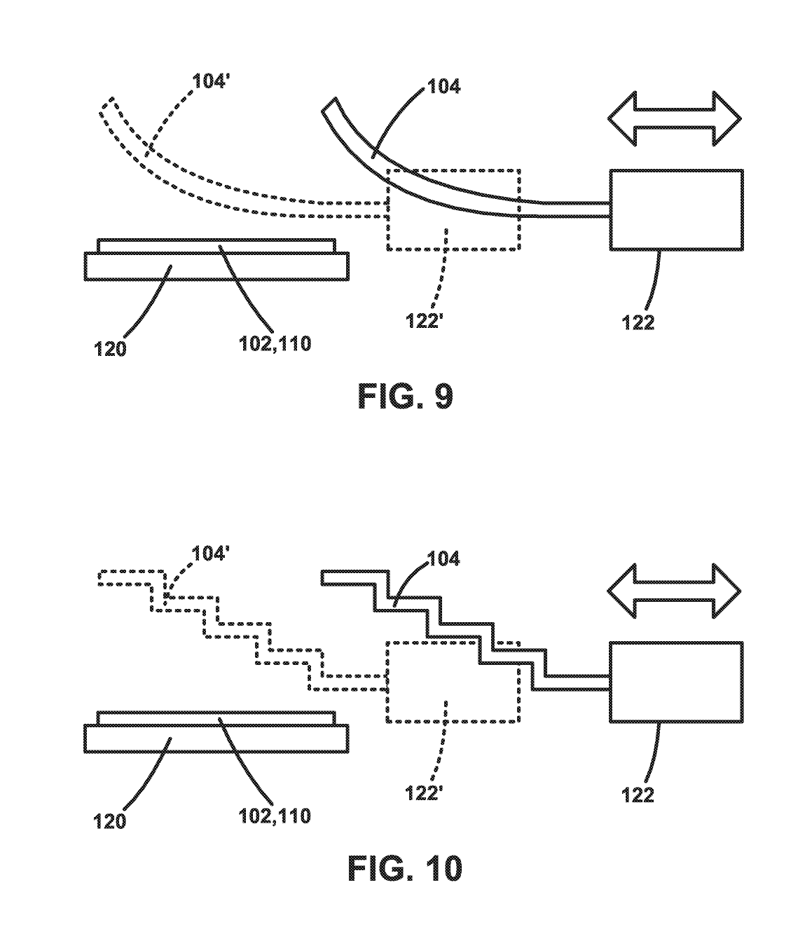

Similar 3D effects can be realized through the configurations illustrated in FIGS. 9 and 10. Referring to FIG. 9, the target 104 is curved with respect to the direction of travel (see the arrow) of the target in response to brake application. Like previous configurations, the target 104 can also have a variable shape (e.g., triangular) in order to further improve the sensor response. Thus, as the lateral position of the target 104 and coil 110 change, the target plate surface area can change due to the irregular shape while, at the same time, the axial distance between the target and the coil also changes due to the 3D structure. Advantageously, this 3D target configuration can help accelerate the field change or inductance change of the coil (or loss change), and can also help improve the accuracy of the sensor. As the first and second components 120, 122 move relative to each other in response to brake application, the sensor 102 can provide an accurate output indicative of the brake pad wear.

Referring to FIG. 10, the target 104 has a stepped configuration with respect to the direction of travel (see the arrow) of the target in response to brake application. Like previous configurations, the target 104 can also have a variable shape (e.g., triangular) in order to further improve the sensor response. Thus, as the lateral position of the target 104 and coil 110 change, the target plate surface area can change due to the irregular shape while, at the same time, the axial distance between the target and the coil also changes due to the 3D structure. Advantageously, this 3D target configuration can help accelerate the field change or inductance change of the coil (or loss change), and can also help improve the accuracy of the sensor. As the first and second components 120, 122 move relative to each other in response to brake application, the sensor 102 can provide an accurate output indicative of the brake pad wear.

### Indirect Measurement Implementation—RFID

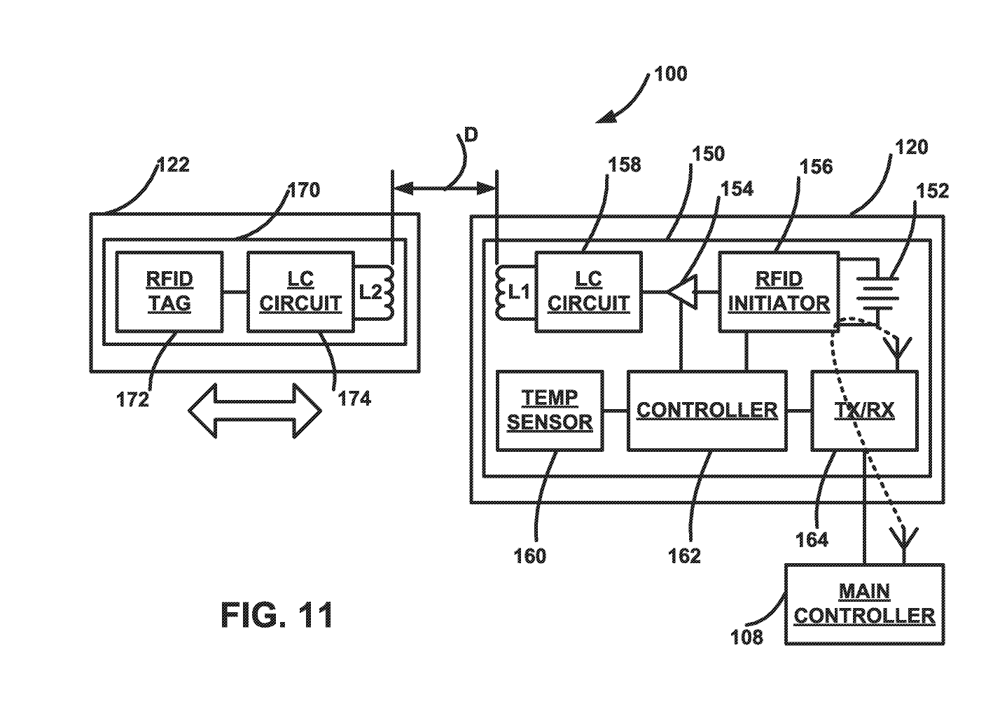

Referring to FIG. 11, according to another implementation of the sensor system 100, the system can utilize one or more radio frequency identification (RFID) circuits connected to the first and second components 120, 122 to measure brake pad wear. In one embodiment, two RFID circuits couple each other through two resonating LC circuits: An active RFID initiator device 150 and a passive RFID tag device 170. The active RFID initiator device 150 includes a power source 152, such as a battery, and therefore serves as a master device or sensor. The RFID tag device 170 is detected by the RFID initiator device 150 and therefore serves as a target in this implementation. The RFID initiator device 150 initiates transmission, and the RFID tag device 170 will respond to the transmission if the signal is strong enough. The strength of the signal is dependent on the distance between the RFID initiator device 150 and the RFID tag device 170.

The ability of the RFID devices device 150, device 170 to communicate with each other is dependent on a signal strength and a coil coupling factor which is related to the distance between the devices, more particularly between the respective coils of the devices. The stronger signal emitted by the RFID initiator device 150, the longer the distance over which the system can communicate. Since, as discussed above, the brake rotor 52 and brake pad 72, 76 are very hot, they are not ideal locations for mounting electrical circuits. To overcome this, the first and second components 120, 122 are selected to be two cooler objects in the structure adjacent or surrounding the brake pad system 50. The components 120, 122 are also selected to ensure that the distance change between them is associated with the pad thickness change proportionally. For example, using a simple snap-on/clip-in fastening method, the second component 122 upon which the RFID tag device 170 can be mounted is a brake pad holder 70, 74.

The component 120 upon which the RFID initiator device 150 is mounted can, for example, be the brake support bracket 56. As the brake pads wear out, the distance (indicated generally at “D” in FIG. 11) between the RFID devices device 150 and device 170 also increases with the same proportion. To maintain the successful communication between the two RFID devices, as the distance D increases, the RFID initiator device 150 has to output more power to overcome the signal loss resulting from the increased distance. The transmission level of the RFID initiator device 150 necessary to generate a response from the RFID tag device 170 is associated with the brake pad thickness. This RFID implementation of the brake wear sensing system 100 system can be directly communicated to the sensor controller 106 and main controller 108 through either a wired (solid) or wireless (dashed) connection.

The RFID tag device 170 includes RFID tag circuitry 172 programmed or otherwise configured to have a unique identifier (ID number, etc.) and an LC circuit 174 including a coil or antenna L2. The RFID initiator device 150 includes RFID initiator circuitry that is programmed or otherwise configured to generate an interrogation signal “looking” for the presence of the RFID tag device 170. An adjustable power amplifier 154 amplifies the interrogation signal provided to an LC circuit 158, which transmits the interrogation signal via antenna/coil L1. The RFID initiator device 150 also includes a controller 162 that is operatively connected to the initiator circuit 156, the amplifier 154, a temperature sensor 160, and transmission/reception circuitry 164.

In operation, the RFID initiator device 150 interrogates the physical space surrounding the antenna L1 for the presence of the RFID tag device 170. The communication range between two RFID resonating circuits is associated with the coupling factor K and the transmitting power, which is controlled through the amplifier 154, from the RFID initiator device 150. The coupling factor K is associated with the flux coupling between coil L1 and coil L2. The distance between L1 and L2 affects the K. The shorter distance, the stronger coupling factor is and less the RFID transmission power is required to maintain the communication. By controlling the power level of the amplifier 154, we can adjust the distance within which the RFID initiator 150 and tag 170 can communicate. Therefore, mounting the devices 150, 170 on the first and second components 120, 122, respectively, the distance between the components can be measured by monitoring the output power level of the amplifier 154.

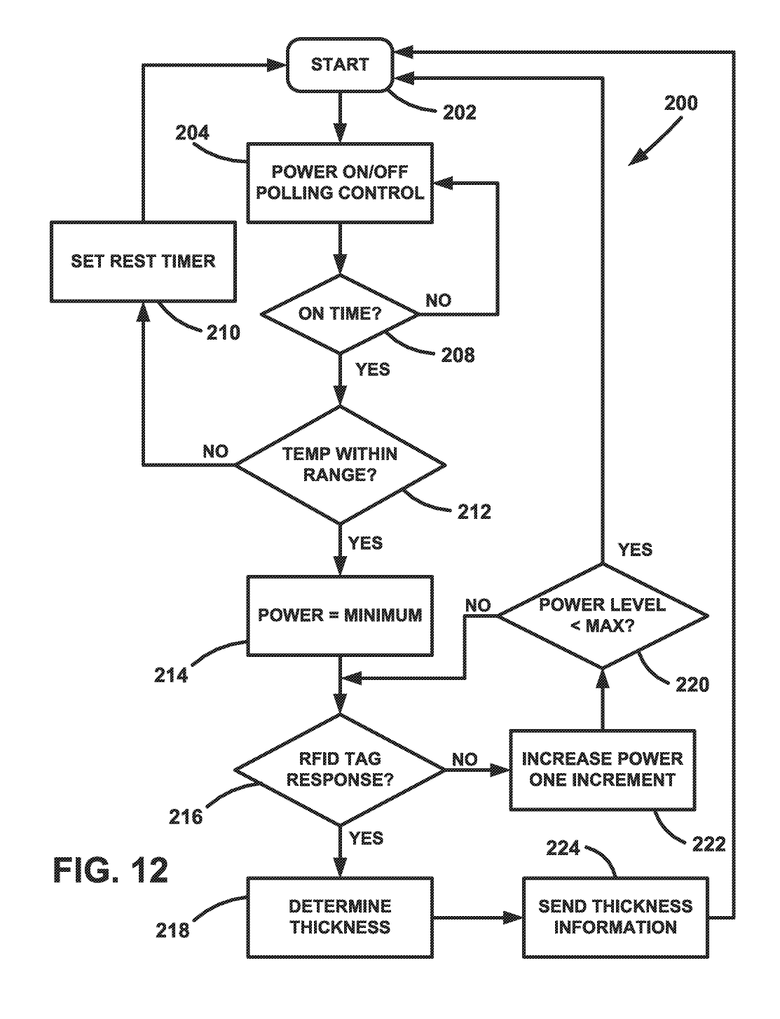

An example of a process for diagnosing brake pad wear using the system 100 of FIG. 11 is illustrated in FIG. 12. The steps illustrated in FIG. 12 and described below are examples of steps that can be performed by the system 100. Additional steps could be added, and some steps could be omitted, skipped, repeated or performed in alternative orders. Referring to FIG. 12, the process 200 begins at step 202 and proceeds to step 204, where power on/off interrogation control is performed. At this step, a determination is made as to whether a interrogation should commence, based on a time function, such as a timer. At step 208, if it is not time for interrogation, the process 200 reverts back to step 204. If it is time for interrogation to proceed, the process 200 proceeds to step 212.

At step 212, a determination is made as to whether the operating temperature of the system 100 is within a predetermined operating range. If the temperature is not within the operating range, the process 200 proceeds to step 210, where the timer is reset, and the process starts over at step 202. If the temperature is within the operating range, the process proceeds to step 214, where the power of the amplifier 154 is set to the minimum. The process 200 then proceeds to step 216, where a determination is made as to whether the RFID initiator 150 receives a response from the RFID tag 150. If a response is received, the process 200 proceeds to step 218 where a determination of brake pad thickness is made based on the power level. This can be performed, for example, via a lookup table. The process 200 then proceeds to step 224, where the determined brake pad thickness is transmitted. The process 200 then proceeds back to step 202 and starts over.

If, at step 216, the RFID initiator 150 does not receive a response from the RFID tag 170, the process proceeds to step 222, where the power level is increased one predetermined increment. The process 200 then proceeds to step 220 where a check is performed to determine whether the power level is less than a predetermined maximum power level. If the power level is not less than the predetermined maximum, meaning that the maximum power level has been reached, the process 200 proceeds to step 202, and the starts over. If the power level is less than the predetermined maximum, the process 200 proceeds to step 216 where the determination as to whether the RFID initiator 150 receives a response from the RFID tag 170 is repeated. The process 200 repeats this loop of steps 216, 222, and 220 until an RFID tag response is received, allowing brake pad wear to be calculated, or until the maximum power level is reached, causing the process to start over.

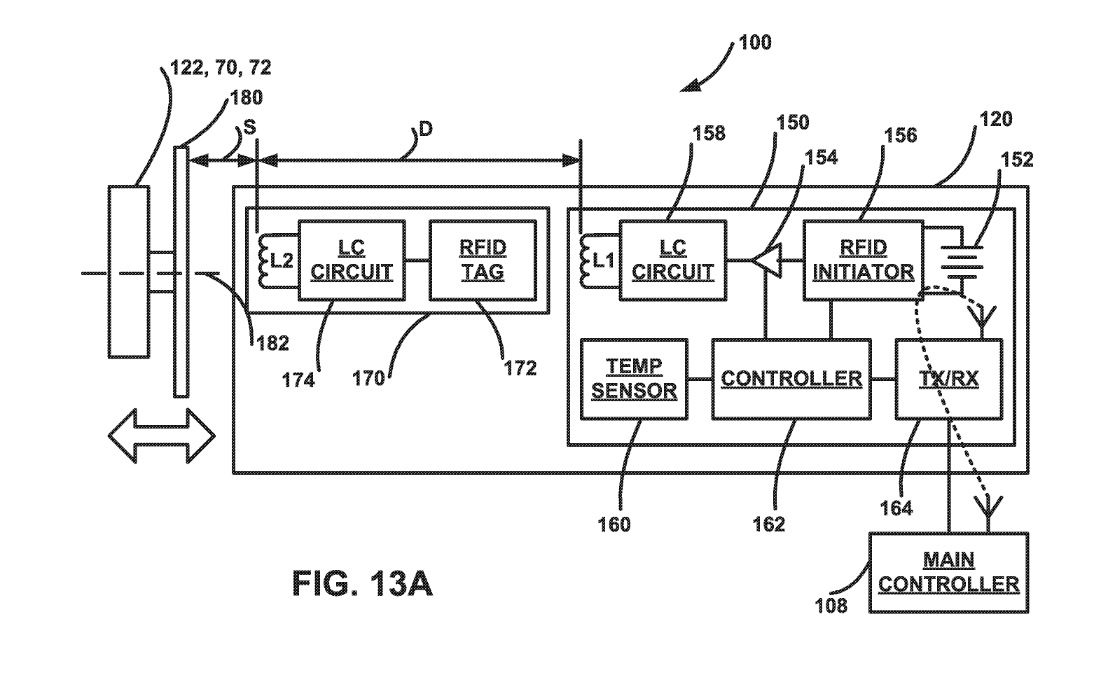

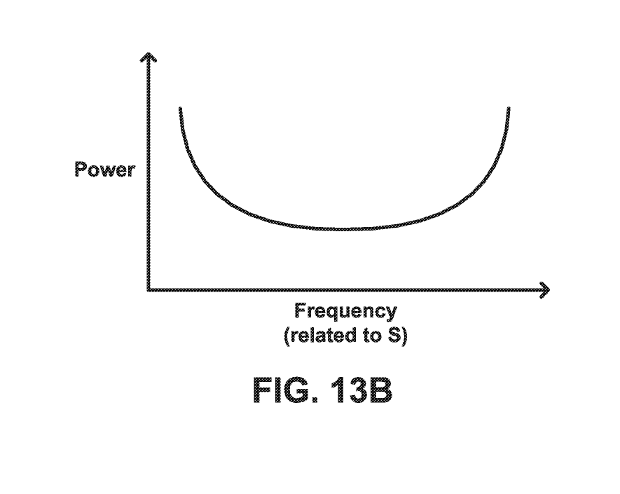

FIGS. 13A and 13B illustrate another implementation utilizing the RFID initiator 150 and tag 170. In this implementation, a metal target 180 is connected to the second component 122 which, in this instance, is a component that moves in response to brake application, such as the inner brake pad holder 70 or the inner brake pad 72. The RFID tag device 170 and the RFID initiator 150 can be mounted on the same structure, such as the first vehicle component 120, which can be fixed in position, such as the brake bracket 56. The target 180 is configured to move along an axis 182 toward and away from the antenna L2 of LC tank circuit 172 in response to operation of the brakes.

In the implementation illustrated in FIG. 13A, the target 180 is oriented with its face perpendicular to the axis 182 and can have a shape that is regular, such as round or square. The target 180 could alternatively be irregularly shaped (e.g., triangular) and could be oriented with its face parallel to the axis so that the irregular shaped target moves over the coil L2 in response to brake application (see, e.g., FIGS. 6-10).

In operation, when the brakes are applied, the distance between the target 180 and the antenna L2 of the RFID tag device 170, indicated generally at “S” in FIG. 13A changes. When the distance S is decreasing, the target 180 will affect the inductance of coil L2. The change in the inductance of coil L2 will change the resonating frequency of the LC tank circuit 174 of the RFID tag device 170. The RFID initiator device 150 and its coil L1 will be a certain fixed distance, indicated generally at “D” in FIG. 13A, from the RFID tag device 170 and its coil L2.

The RFID initiator device 150 transmits its interrogation signal at certain predetermined power levels and at certain predetermined frequencies. The RFID initiator device 150 records the power level at which successful communication with the RFID tag device 170 is established for each frequency. In this manner, the RFID initiator device 150 builds a table of power levels required to establish tag communication for each frequency.

Since, as described above, pad wear results in the target 180 affecting the resonant frequency of the RFID tag device 150, and since different RFID tag resonant frequencies will require different power to establish communication with the initiator, the power vs. frequency curve can be used to determine the distance between the target 180 and the RFID tag device 170, which is indicative of brake pad wear.

In this implementation, the RFID tag device 170 need not be mounted on the brake pad holder, so it is not subjected to the heat associated with that structure. The system 100 in this implementation utilizes three different temperature zones: (1) the brake pad holder zone—very high temperature—only the metal target 180 is mounted in this area, no electrical components; (2) “S” distanced component zone—higher temperature, but not too high—RFID tag device, which has no battery, so can withstand more heat than the RFID initiator device 150; and (c) low temperature zone—the RFID initiator device is battery powered and therefore requires mounting in a lower temperature zone. Additionally, since the RFID tag device 170 is small, it is easier to mount, so mounting it in a location closer to the brake pad holder is easier.

The system 100 detects brake pad wear in response to the transmission power level of the RFID initiator device 150 necessary to elicit a response from the RFID tag device 170. As the distance between these devices 150, 170 increases due to brake pad wear, the amount of power required to complete the communication transaction will increase. Changes in the required power are therefore indicative of brake pad wear. Of course the power provided by the amplifier 154 is affected by the temperature of the RFID initiator device 150. Therefore, the controller 162 can be programmed to perform temperature compensation using temperature data obtained from the temperature sensor 160. The controller 162 can then transmit a brake pad wear indication signal, wired or wirelessly, to the main controller 108 via the TX/RX circuit 164.

Those skilled in the art will appreciate that the system 100 doesn't have to measure brake pad wear on a continual basis, every minute and at every temperature. The system 100 can be configured to measure brake pad wear at certain time intervals and within certain temperature ranges. Since most circuit components' characteristics vary with temperature, the measurement result can be temperature compensated, as long as the temperature is measured accurately. This is why it may be beneficial to perform the calculations within certain temperature ranges.

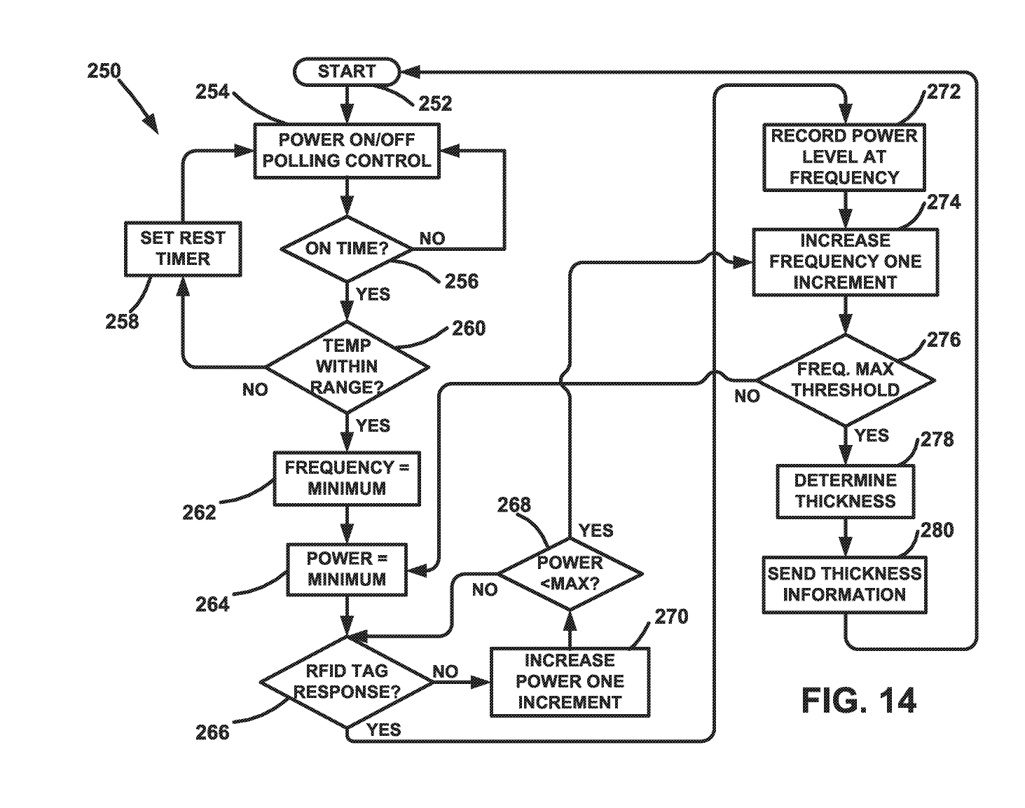

An example of a process for diagnosing brake pad wear using the system 100 of FIGS. 13A and 13B is illustrated in FIG. 14. The steps illustrated in FIG. 12 and described below are examples of steps that can be performed by the system 100. Additional steps could be added, and some steps could be omitted, skipped, repeated or performed in alternative orders. Referring to FIG. 14, the process 250 begins at step 252 and proceeds to step 254, where power on/off interrogation control is performed. At this step, a determination is made as to whether a interrogation should commence, based on a time function, such as a timer. At step 256, if it is not time for interrogation, the process 250 reverts back to step 254. If it is time for interrogation to proceed, the process 250 proceeds to step 260.

At step 260, a determination is made as to whether the operating temperature of the system 100 is within a predetermined operating range. If the temperature is not within the operating range, the process 250 proceeds to step 258, where the timer is reset, and the process starts over at step 254. If the temperature is within the operating range, the process 250 proceeds to step 262, where the communication frequency is set to a minimum value. The process 250 then proceeds to step 264, where the power of the amplifier 154 is set to the minimum.

The process 250 then proceeds to step 266, where a determination is made as to whether the RFID initiator 150 receives a response from the RFID tag 150. If no RFID tag response is received, the process 250 proceeds to step 270, where the power level of the amplifier 154 is increased one increment. The process 250 then proceeds to step 268, where a determination is made as to whether maximum power has been reached. If maximum power has not been reached, the process 250 proceeds to step 266, where a determination is made as to whether the RFID initiator 150 receives a response from the RFID tag 150. From this, it can be seen that, for any given frequency, amplifier power is stepped up until a response is received from the RFID tag 150 or maximum power is reached.

If, at step 266, an response is received from the RFID tag 150, the process 250 proceeds to step 272 where the power level and frequency are recorded. The process 250 then proceeds to step 274, where the frequency is increased one predetermined increment. The process then proceeds to step 276, where a determination is made as to whether the frequency has reached a predetermined maximum threshold. If the frequency has not reached the maximum, the process 250 reverts back to step 264, where power is set to minimum and increased incrementally until, at step 266, an RFID tag response is received, and the process 250 proceeds as described. From this, it can be seen that the frequency is increased incrementally and, for each frequency, the power is increased incrementally until the power necessary to illicit a response from the RFID tag is reached. At step 276, once the maximum frequency is reached, the brake pad thickness can be determined from the various frequencies and power levels recorded at step 272, for instance, from a look-up table that correlates frequency and power combinations to pad thickness. The correlation can, for example, be one similar to that illustrated in FIG. 13B, in which power and frequency are related to the distance S between the target 180 and the RFID tag device 170. The process 250 then proceeds to step 280, where the determined brake pad thickness is transmitted. The process 250 then proceeds back to step 252 and starts over.

From the above description of the invention, those skilled in the art will perceive improvements, changes and modifications. Such improvements, changes and modifications within the skill of the art are intended to be covered by the appended claims.

We claim:

1. A brake pad wear measuring system for measuring brake pad wear for a vehicle disc brake system, the brake pad wear measuring system comprising:
an inductive sensor operable to create a magnetic field; and
a target;
wherein at least one of the sensor and the target are mounted for movement along a braking axis with a component of the disc brake system,
wherein the positions of the sensor and target relative to each other changes in response to application of the disc brake system,
wherein the distance that the sensor and target move relative to each other in response to application of the disc brake system increases an amount that is equal to the total wear of the inner and outer brake pads, and
wherein the sensor is responsive to the change in inductance caused by movement of the target in the magnetic field to provide a signal indicative of brake pad wear.

2. The brake pad wear measuring system recited in claim 1, wherein the target has a face that extends along a target plane and is oriented parallel with a coil winding plane of the sensor, and wherein the movement of the target relative to the sensor is along an axis that extends perpendicular to both the target plane and the coil winding plane.

3. The brake pad wear measuring system recited in claim 1, wherein the target has a face that extends along a target plane and is oriented parallel with a coil winding plane of the sensor, and wherein the movement of the target relative to the sensor is along an axis that extends parallel to both the target plane and the coil winding plane.

4. The brake pad wear measuring system recited in claim 3, wherein the system is configured so that the target is offset from the coil prior to brake application and moves over the coil in response to brake application.

5. The brake pad wear measuring system recited in claim 4, wherein the axial spacing of the target and the sensor as measured parallel to the braking axis remains constant throughout brake application.

6. The brake pad wear measuring system recited in claim 4, wherein the target is tapered as viewed perpendicular to the target plane.

7. The brake pad wear measuring system recited in claim 6, wherein the target has a stepped configuration as viewed parallel to the target plane.

8. The brake pad wear measuring system recited in claim 4, wherein the target has a stepped configuration as viewed parallel to the target plane.

9. The brake pad wear measuring system recited in claim 1, wherein the target has a face that extends along a target plane and is oriented at an angle with respect to a coil winding plane of the sensor, and wherein the movement of the target relative to the sensor is along an axis that extends parallel to both the target plane and the coil winding plane.

10. The brake pad wear measuring system recited in claim 9, wherein the target is tapered as viewed perpendicular to the target plane.

11. The brake pad wear measuring system recited in claim 1, wherein the target has a face that is curved and extends along curved path such that a leading edge of the target is positioned farthest from the sensor coil.

12. The brake pad wear measuring system recited in claim 1, wherein the sensor comprises an RFID initiator device and the target comprises an RFID tag device.

13. The brake pad wear measuring system recited in claim 12, wherein RFID initiator device comprises an initiator coil, an amplifier for delivering power for exciting the initiator coil, and a controller for controlling the operation of the amplifier, wherein the RFID initiator device determines the wear on the brake pads in response to the power required from the amplifier to elicit a response from the RFID target device.

14. The brake pad wear measuring system recited in claim 1, wherein the target is mounted for movement with a floating caliper or a piston of a floating caliper disc brake system wherein the piston supports an inner brake pad and the floating caliper supports an outer brake pad, and wherein the piston and floating caliper move toward each other along the braking axis in response to application of the brake system so that the brake pads engage and apply a braking force to a brake rotor.
